(19) United States
(12) Patent Application Publication
(10) Pub. No.: US 2004/0152799 A1
(43) Pub. Date: Aug. 5, 2004

(54) Flexible radiation curable compositions

(76) Inventors: Christopher Wayne Miller, Acworth, GA (US); Jo Ann Arceneaux, Marietta, GA (US); Larisa Kagansky, Atlanta, GA (US); Michael J. Idacavage, Marietta, GA (US); Marcus Hutchins, Rockmart, GA (US); Morris Arthur Johnson, Atlanta, GA (US)

Correspondence Address: WENDEROTH, LIND & PONACK, L.L.P., 2033 K STREET N. W., SUITE 800, WASHINGTON, DC, 20006-1021, US

(21) Appl. No.: 10/355,194

(22) Filed: Jan. 31, 2003

(51) Int. Cl. C08F 2/46; B32B 27/00

(52) U.S. Cl. 522/104; 522/149; 522/162; 522/174; 428/500

(57) ABSTRACT

Polymerizable compositions are described containing urethane (meth)acrylate oligomers and certain polymerizable monomers useful in thermoforming or in-mold decoration applications.

### FIELD OF THE INVENTION

The invention relates to improved radiation curable compositions comprising radiation curable oligomers, radiation curable monomers, and various additives. Such types of compositions are useful for making radiation curable inks and coatings.

### DESCRIPTION OF RELATED ART

Radiation curable compositions are commonly used as inks, coatings, and adhesives. Advantages of the radiation curable compositions over conventional solvent-borne compositions include: speed of application and curing, decreased levels of VOC's (volatile organic compounds), and spatial discretion in curing.

Radiation curable compositions that exhibit flexibility after cure are known in the art, and have been used for various applications including fiber-coating, thermoforming, in-mold-decoration (IMD), and in-mold-coating (IMC) processes. Generally, the prior art in thermoformable radiation curable resins provides coatings and inks which exhibit flexibility, but which also exhibit the undesirable property of high surface tack (stickiness) after curing. High surface tack causes difficulties with handling the printed and/or thermoformed articles because stacking of tacky articles leads to sticking and transfer of inks/coatings to the backs of adjacent articles in the stack. Methods to offset the high surface tack after curing are known and include: addition of significant amounts of inert fillers, dusting printed and/or thermoformed objects with powder prior to stacking, and insertion of intermediate films between printed and/or thermoformed objects prior to stacking. These methods typically partially or significantly compromise utility of the flexible resins by altering the rheology of the curable compositions, adding extra steps in the processing of the articles, and/or decreasing the flexibility and elongation at break of the cured inks and/or coatings. Other radiation curable resins for inks and coatings showing good flexibility with low surface tackiness typically do not show good adhesion to a range of polymeric substrates.

IMD and IMC processes are known and the bulk of the prior art in the field involves use of solvent-borne coatings or water-borne coatings with or without a tie-coat layer, which serves to increase adhesion between the cured ink/coating and the injected polycarbonate layer in the IMD laminates. As noted previously, solvent-borne coatings have the distinct disadvantage of releasing significant quantities of VOC's during processing. Water-borne coatings are typically more environmentally friendly, though they require the use of significant energy expenditures to remove the water after application. Utilization of tie-coat layers in IMD processing is not preferred because it adds an extra step to the process.

WO 02/50186 A1 provides for a radiation curable coating or ink composition useful with or without solvent and without the use of a tie-coat layer in IMD processes. WO 02/50186 A1 specifically teaches that oligomers containing linear aliphatic or aromatic polycarbonate-based polyol residues in the oligomer backbones show benefits for adhesion in IMD applications, and that such oligomers may be optionally combined with oligomers of other functionality such as polyester and polyether to modify the flexibility and other characteristics of radiation curable compositions containing them. However, the invention of WO 02/50186 A1 requires the use of mostly polycarbonate-based radiation curable oligomers to generate adequate adhesion in the IMD articles, thereby limiting the range of oligomers, and the flexibilities of those oligomers, which may be used in IMD processes.

Heterocyclic-functional radiation curable monomers are also known in the art, and certain examples of this class of materials have been recognized in several instances as exhibiting enhanced rates of curing as disclosed in U.S. Pat. No. 5,047,261 and U.S. Pat. No. 5,360,836. A mechanism to explain the surprising rapid polymerization rates is provided in WO 02/42383 A1. Therein is taught the hypothesis that attachment of functional groups which have a calculated Boltzman average dipole moment of greater than 3.5 Debye to acrylate groups produces monomers that show unexpectedly efficient photopolymerization kinetics leading to very high rates of curing. The inventors of WO 02/42383 further teach that inclusion of such monomers in radiation curable compositions allows surprising increases in the rates of curing of those compositions and that such rapid rates of curing are useful in coating of glass fibers in processing of fiber optic cabling.

### OBJECTIVES OF THE INVENTION

The overall objective of the present invention is to provide radiation curable compositions which demonstrate essential characteristics in combination including: high flexibility, high adhesion to polymeric substrates, low post-cure surface tackiness, and low shrinkage upon cure, such as are useful and necessary for preparation of substantially solvent-free radiation curable inks and coatings for thermoforming applications and other applications where such properties in combination are useful. A particular objective of the present invention is to provide radiation curable compositions which demonstrate the previously noted essential characteristics in addition to adhesion to injection molded polycarbonate and/or other thermoplastic resins in IMD and IMC processes.

### BRIEF SUMMARY OF THE INVENTION

The overall objective has been attained using radiation curable compositions comprising urethane (meth)acrylate oligomers with high flexibility and high percentage elongation at break and radiation curable monomers. Additionally, diluents, radical-generating initiators, and various additives may optionally be employed. The inventive compositions yield cured inks and/or coatings which exhibit the novel combination of the following essential performance characteristics: high flexibility, high adhesion to various polymeric substrates typically used for thermoforming applications, little or no post-cure surface tackiness, and low shrinkage upon cure.

The particular objective has been attained using radiation curable compositions described above in particular combination with a polymerizable monomer component wherein the polymerizable monomer component is selected such that it remains significantly or substantially unpolymerized after application and curing of the composition and thereby enhances adhesion of the radiation cured coatings and inks to injection molded thermoplastics. Such combinations provide substantially solvent-free radiation curable compositions useful for inks and coatings in IMD, IMC, and thermoforming processes.

### BRIEF DESCRIPTION OF THE DRAWINGS

FIG. 1 depicts an IMD laminated article of the present invention wherein the layer of injected polycarbonate is labeled 1), the printed and cured ink layer is labeled 2), and the polycarbonate substrate is labeled 3).

FIG. 2a depicts a one-layer polycarbonate substrate wherein the layer is labeled 4).

FIG. 2b depicts a polycarbonate substrate printed with a radiation curable ink of the present invention wherein the polycarbonate substrate is labeled 4) and the ink layer is labeled 5).

FIG. 2c depicts a thermoformed printed substrate in accordance with the present invention wherein the polycarbonate substrate is labeled 4) and the ink layer is labeled 5).

FIG. 2d depicts an injection molded thermoformed printed article of the present invention produced via the IMD process wherein the polycarbonate substrate is labeled 4), the ink layer is labeled 5), and the injected polycarbonate layer is labeled 6).

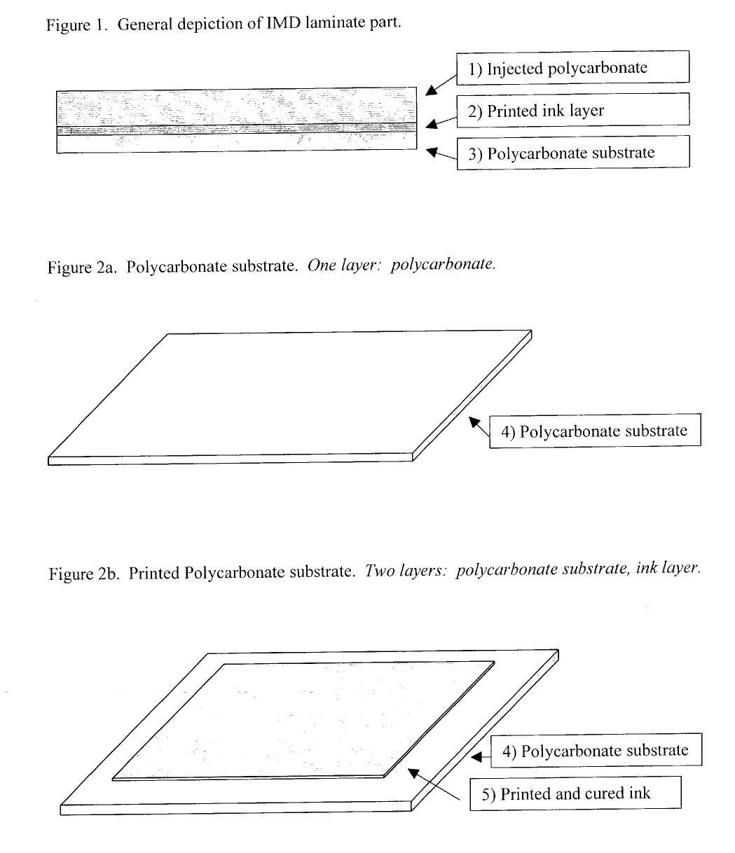

### DETAILED DESCRIPTION OF THE INVENTION

### Overall Objective

The improvement in performance of the inventive radiation curable composition over the prior art regarding the overall objective of the present invention lies in the attainment, in combination, of useful and essential properties including the following:

a) high flexibility and high percent elongation at break as afforded by certain base oligomers which exhibit elongation at break of about 100-900%,

b) high adhesion to a wide variety of polymeric substrates including polycarbonate, polyvinylchloride, polystyrene, polyethylene-terephthalate-G, and polyethylene-terephthalate, the latter two of which are known in the art to be exceedingly difficult substrates upon which to get adhesion with substantially solvent-free radiation curable compositions,

c) little or no post-cure surface tackiness at temperatures from room temperature up to about 65° C. to allow stacking of printed or coated articles without cooling and without use of covering layers or powders, and

d) low shrinkage upon cure as afforded by the base oligomers, which exhibit shrinkage upon cure of less than about 2%, and typically about 1% or less.

It has been found that the oligomer/monomer combination upon which the radiation curable compositions are based affects useful properties a)-d), and that enhancing property a) using oligomers known in the art typically had detrimental effect on property c). It has been found that by the appropriate choice of constituent components of the radiation curable oligomers, and by particular combination of those constituent components, high flexibility and percent elongation at break could be obtained in combination with low post-cure surface tack and adhesion to a wide variety of polymeric substrates.

Radiation curable compositions were produced with components from among the categories: radiation curable urethane (meth)acrylate oligomer, radiation curable monomers and diluents, radical-generating photoinitiators, and additives. Constituents in those categories, along with the weight percentages of each category, useful in radiation curable compositions of the first objective are set forth below. All percentages are by weight based upon the total weight of the composition. All molecular weights used in the descriptions and claims of the present invention are given as number-average molecular weight in the units of grams per mole.

1) Radiation Curable Urethane (Meth)acrylate Oligomer (About 5-85%)

This component is generally defined as an acrylate and/or methacrylate functional urethane oligomer with one to four polymerizable acrylate and/or methacrylate groups, and preferably with two polymerizable acrylate and/or methacrylate groups. The molecular weight range of the oligomer is about 1,000-20,000 g/mol, preferably about 2,500-15,000 g/mol, and most preferably about 4,000-10,000 g/mol. The oligomer has an elongation at break of greater than about 100%, as measured by tensile testing of a radiation-cured thin free-film of the oligomer, and preferably greater than about 300% elongation at break, and most preferably greater than about 500% elongation at break.

Scheme 1. General Structure for High Elongation Urethane (Meth)acrylate.

CH₂═CH(R₁)—COO—R₂—OCONH—R₃—NHCOO—[Z—OCONH—R₃—NHCO]ₙ—O—R₂—OCO—CH(R₁)═CH₂

where:

R₁=H, CH₃

R₂=CH₂CH₂, CH₂CH(CH₃)CH₂, CH₂CH₂O[CO(CH₂)₅]_{q}, CH₂CH₂CH₂CH₂, CH₂CHCH₃, CH₂CH₂CH₂, CH₂CH₂CH₂CH₂CH₂

n=1 to about 20

q=1 to about 20

R₃=aliphatic, cycloaliphatic, heterocyclic, or aromatic radical with molecular weight about 25-10,000 g/mol

Z=moiety from one or more of: polyesters, polyethers, polyglycols, polycarbonates, polyurethanes, polyolefins; having a number average molecular weight of about 25-10,000 g/mol. wherein said Z moieties have the following formulae:

polyesters: -[A-OCO-B-COO]ₘ-A- or -[E-COO]ₘ-D-[OCO-E]ₘ-

polyethers/polyglycols: -A-[G-O]ₘ-G- or -G-[O-G]ₘ-O-A-O-[G-O]ₘ-G- or -A-

polycarbonates: -J-[OCOO-J]ₘ-

polyurethanes: -L-[OCON-Q-NCOO-L]ₘ-

polyolefins: -Q-[R]ₘ-Q-

where:

A=linear, branched, or cyclic aliphatic or aromatic radical with a molecular weight of about 14 g/mol-1,000 g/mol based upon C and H, and optionally containing N, O, S, or Si

B=linear, branched, or cyclic aliphatic or aromatic radical with a molecular weight of about 14 g/mol-1,000 g/mol based upon C and H, and optionally containing N, O, S, or Si

D=linear, branched, or cyclic aliphatic or aromatic radical with a molecular weight of about 14 g/mol-1,000 g/mol based upon C and H, and optionally containing N, O, S, or Si

E=linear, branched, or cyclic aliphatic or aromatic radical with a molecular weight of about 14 g/mol-1,000 g/mol based upon C and H, and optionally containing N, O, S, or Si

G=linear, branched, or cyclic aliphatic radical with a molecular weight of about 14 g/mol-1,000 g/mol based upon C and H, and optionally containing N, O, S, or Si

J=linear, branched, or cyclic aliphatic or aromatic radical with a molecular weight of about 14 g/mol-2,000 g/mol based upon C and H, and optionally containing N, O, S, or Si

L=linear, branched, or cyclic aliphatic or aromatic radical with a molecular weight of about 14 g/mol-2,000 g/mol based upon C and H, and optionally containing N, O, S, or Si

Q=linear, branched, or cyclic aliphatic or aromatic radical with a molecular weight of about 14 g/mol-2,000 g/mol based upon C and H, and optionally containing N, O, S, or Si

R=linear, branched, or cyclic aliphatic or aromatic radical with a molecular weight of about 14 g/mol-4,000 g/mol based upon C and H, and optionally containing N, O, S, or Si

m=1 to about 1,000

The oligomer may be prepared by reacting a hydroxy-functional (meth)acrylate component and one or more polyols with one or more isocyanate functional compounds, as defined following, via standard synthetic methods. Examples of components useful in the synthesis of the radiation curable oligomers are given following.

### Hydroxy-Functional (Meth)acrylate Component

Polymerizable (meth)acrylate functionality is incorporated into the said oligomer by reaction of the hydroxy functional group of hydroxy functional (meth)acrylate compound, with molecular weight of about 100 g/mol-1,500 g/mol, with an isocyanate functional compound as defined following. Examples of the hydroxy-functional (meth)acrylate component used to synthesize the oligomer may include: 2-hydroxyethylacrylate (2-HEA), 2-hydroxypropylacrylate (2-HPA), hydroxybutylacrylate (HBA), 2-hydroxyethylmethacrylate (2-HEMA), 2-hydroxypropylmethacrylate (2-HPMA), hydroxybutylmethacrylate (HBMA), and 2-[(1-oxo-2-propenyl)oxy]ethylester, and alkoxylated variants of the same. The preferred embodiments of the oligomer include examples synthesized using 2-hydroxyethylacrylate and/or 2-[(1-oxo-2-propenyl)oxy]ethylester.

### Polyol Component

Examples of the polyol used to synthesize the oligomer include hydroxy-functional oligomers, homopolymers, and/or copolymers from among the following types: aliphatic and/or aromatic polyester, aliphatic and/or aromatic polyether, aliphatic and/or aromatic polycarbonate, aliphatic and/or aromatic polyurethane, and polyolefin. Various polyol types may be incorporated into the oligomer portion of the composition by blending oligomers made with different individual polyol types and/or by making oligomers that include two or more polyols types in a single oligomer backbone. The polyols may be within the molecular weight range about 25 10,000 g/mol, and preferably in the range about 1000-4000 g/mol.

Examples of materials that may comprise a polyester polyol backbone include, but are not limited to, the following polyols: butanediol, propanediol, ethyleneglycol, diethyleneglycol, hexanediol, propyleneglycol, dimer-diol, cyclohexanedimethanol, 2-methylpropanediol, and the like; and include, but are not limited to, the following dibasic acids: adipic acid, phthalic acid, isophthalic acid, terephthalic acid, dodecandioic acid, poly(epsilon-caprolactone), dimer acid, fumaric acid, succinic acid, and the like. Polyester polyols may also optionally be prepared as poly-lactones such as poly(epsilon-caprolactone) by ring-opening polymerization of epsilon-caprolactone, or optionally by copolymerization of epsilon-caprolactone with one or more of the polyols mentioned previously.

Examples of materials that may comprise a polyether polyol homopolymer or copolymer backbone include, but are not limited to, the following: poly(ethylene glycol), poly(propylene glycol), poly(tetrahydrofuran), poly(3-methyl-tetrahydrofuran), poly(bisphenol-A-glycidylether), poly(hexamethyleneglycol), and the like. Hydroxy functional polyols prepared by ring-opening homopolymerization or copolymerization of cyclic ethers such as tetrahydrofuran, ethylene oxide, cyclohexene oxide, and the like may also be used.

Examples of materials that may comprise a polycarbonate polyol backbone include, but are not limited to the following: poly(hexanediol carbonate), poly(butanediol carbonate), poly(ethyleneglycol carbonate), poly(bisphenol-A carbonate), poly(tetrahydrofuran) carbonate, poly(nonanediol carbonate), poly (3-methyl-1,5-pentamethylene carbonate), and the like.

Examples of materials that may comprise a polyurethane polyol backbone include, but are not limited to the following polyols: butanediol, hexanediol, ethyleneglycol, diethyleneglycol, and the like; and may include, but are not limited to, the following isocyanates: hexamethylenediisocyanate, isophorone-diisocyanate, bis(4-isocyanatocyclohexyl)methane, toluene-diisocyanate, diphenylmethane-4,4′-diisocyanate, trimethylhexamethylene diisocyanate, tetramethyl-m-xylene diisocyanate, and the like, as well as isocyanate functional biurets, allophonates, and isocyanurates of the previously listed isocyanates.

A particularly useful combination of polyols in the oligomer synthesis is mixed aliphatic/aromatic polyester polyols with polyether polyol wherein such combinations can be derived by mixing individually prepared oligomers or by using the polyols in combination in an individual extended oligomer.

### Isocyanate Component

The isocyanate functional compound used to synthesize the oligomer may include, but are not limited to, one or more of the following examples of difunctional aromatic and/or aliphatic isocyanates: hexamethylene-diisocyanate (HMDI), isophorone-diisocyanate (IPDI), bis(4-isocyanatocyclohexyl)methane, toluene-diisocyanate (TDI), diphenylmethane-4,4′-diisocyanate (MDI), trimethylhexamethylene diisocyanate, tetramethyl-m-xylene diisocyanate. Particularly useful examples of isocyanates include hexamethylene-diisocyanate (HMDI) and isophorone-diisocyanate (IPDI), which engender flexibility in the radiation curable oligomer. Optionally, isocyanate functional biurets, allophonates, and isocyanurates of the previously listed or similar isocyanates may be used.

2. Radiation Curable Monomers and Diluents (About 0.1-50%)

Radiation curable monomers are useful for adjusting the rheology and viscosity of the radiation curable compositions, modifying the post-cure scratch and abrasion resistance of the radiation curable compositions, modifying the pre-cure and post-cure adhesion characteristics of the radiation curable compositions on various substrates, modifying the chemical resistance of the radiation curable compositions, and modifying the post-cure flexibility of the radiation curable compositions. For the present invention of the overall objective, radiation curable monomers and diluents may be selected from among the group: (meth)acrylate, N-vinylamide, vinylether, vinylester, maleimide, propenylether, and (meth)acrylamide. Particularly useful examples of such diluents for the first objective radiation curable compositions include: isobornylacrylate (IBOA), tricyclodecane mono-methanol acrylate, N-vinylpyrrolidinone, N-vinylcaprolactam, and 1-vinyl-2-piperidinone.

3. Additional Radiation Curable Oligomers (About 0.1-50%

Incorporation of additional radiation curable oligomers in the inventive radiation curable composition of the first objective can be of benefit to modify the post-cure tensile properties, post-cure hardness and impact resistance, post-cure scratch and abrasion resistance, pre-cure and post-cure chemical resistance, and pre-cure rheology and viscosity of those compositions. Useful oligomers may be selected from among the following types: polyester (meth)acrylate, urethane (meth)acrylate, polyester (meth)acrylamide, urethane (meth)acrylamide, amino-(meth)acrylate, epoxy (meth)acrylate, vinylether, N-vinylamide, vinylester, maleimide, propenylether.

4. Radical-Generating Initiators (About 0-20%)

The compositions of the overall objective of the present invention may be polymerized or cured by exposure to heat after addition of a thermally-activated radical-producing initiator compound, by direct exposure to actinic and/or ionizing radiation without addition of an initiator compound, and/or preferably by exposure to actinic or ionizing radiation after addition of chemical species capable of generating radicals upon exposure to actinic or ionizing radiation. The preferred embodiments of the compositions of the overall objective of the present invention include radical-generating photoinitiator compounds selected from the group: hydrogen-abstraction photoinitiators, cleavage photoinitiators, maleimide-type photoinitiators, and radical-generating cationic photoinitiators, and are cured by exposure to actinic radiation.

5. Additives (About 0-25%)

Various additives may optionally be included in the inventive composition of the overall objective, as may be useful for preparing radiation curable compositions for inks and/or coatings. Examples of particularly useful types of additives include, but are not limited to, the following: acrylated and/or non-acrylated amine synergists, fillers, defoamers, flow agents, pigments, dyes, pigment wetting agents, surfactants, dispersants, matting agents, and non-polymerizable diluents.

6. Fluorinated Compatibilizer (About 0-5%)

Fluorinated surfactants, oligomers, and polymers are known in the art to be useful in preparing and compatibilizing polymer/polymer blends particularly during melt-extrusion processing. It has been found in the present invention that some fluoropolymer additives provide synergistic benefits for adhesion when combined in radiation curable compositions with the oligomers and monomers described above. The use of the fluoropolymer additives is not necessary to attain the useful combination of benefits of the invention, but may enhance adhesion particularly in IMD, IMC, and other processes. It is postulated that the fluorinated oligomers and/or polymers effect the adhesion benefits by improving wetting of the polymer substrates by the curable composition. Examples of fluoropolymer compatibilizers include: PolyFox™ TB (Omnova), Zonyl® FSG (Dupont), Zonyl® FSN (Dupont), and Fluorad™ FC-4430 (3™ Corporation).

### Particular Objective

The improvement in performance of the inventive radiation curable compositions over compositions of the prior art regarding the particular objective of the present invention lies in the attainment, in combination, of the useful and essential properties including the following:

a) flexibility, as afforded by the base oligomers which exhibit elongation at break greater than 100% and typically greater than about 300%,

b) high adhesion to polycarbonate substrates,

c) adhesion to polycarbonate-based thermoplastics injected upon the ink or coating during IMD and/or IMC processes,

d) thermal stability and temperature resistance to afford stability at processing temperatures used during thermoforming and injection-molding stages of IMD and/or IMC processes,

e) little or no post-cure surface tackiness at temperatures from room temperature up to about 65° C. to allow stacking of printed or coated articles without cooling and without use of covering layers or powders, and

f) low shrinkage upon cure as afforded by the base oligomers typified in the inventive examples, which exhibit shrinkage upon cure of less than about 2%, and typically less than about 1%.

It has been found that the oligomer/monomer combination upon which the radiation curable compositions are built affects useful properties a)-f), and that enhancing property a) using oligomers known in the art typically had detrimental effect on property c). It has been found that by the appropriate choice of constituent components of the radiation curable oligomers, and by particular combination of those constituent components, these performance characteristics could be obtained in combination using various examples of substantially solvent-free radiation curable coatings and inks. It has further been found that particular combination of compositions providing for the overall objective of the present invention with certain particular polymerizable monomer components provides useful properties b) and c).

Before proceeding further, the following is an explanation of the typical operations used in in-mold-decoration and thermoforming processes.

In-Mold-Decoration/Thermoforming Process Review

A. Description of Typical Thermoforming Processes

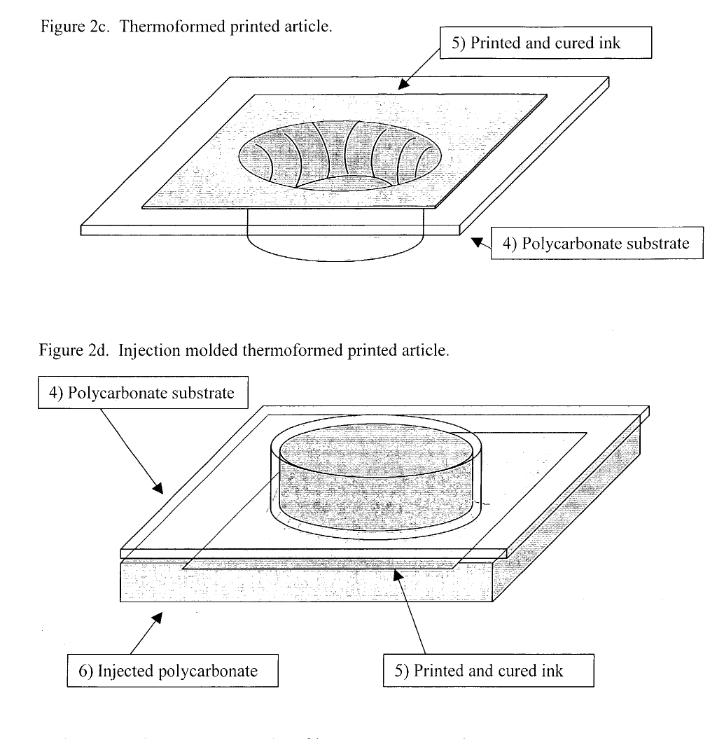

1) A sheet (like an overhead transparency) of polymer (polycarbonate, PET, polystyrene, PVC, etc.) as depicted in FIG. 2a is printed with a graphic design by a screen printing process.

2) The printed ink is cured (that is, polymerized, or otherwise hardened) by passing the print under ultraviolet light on a conveyor belt system yielding a printed substrate as depicted in FIG. 2b.

3) Steps 1) and 2) are repeated for up to 5-6 colors/layers.

4) The printed sheets are then optionally stacked and transported to another location for forming.

5) The printed sheets are clamped into a thermoforming machine and heated by infrared or other radiant heat source, with the temperature and time of the heating operation dependent upon the type of substrate.

6) When the sheet is sufficiently soft, a mold is forcefully pressed into the printed side (or optionally into the unprinted side) of the sheet and vacuum is applied to wrap the sheet tightly onto the mold form.

7) Cooling air is applied to harden the piece, and the formed object is removed from the thermoforming machine resulting in an object as depicted in FIG. 2c.

8) The formed part is then trimmed to the final shape and stored prior to assembly into the finished product (bicycle helmet, soft drink machine cover, sign, etc.).

B. Requirements of Typical Thermoforming Processes

a) For steps 1-3, the ink should exhibit excellent adhesion to the polymer substrate and must show good intercoat adhesion to allow multi-layer printing.

b) For step 4, the printed cured inks should have very low surface tack (stickiness) so that prints stacked on top of each other at elevated temperature and pressure do not stick to each other.

c) For steps 5-6, the ink should exhibit reasonable resistance to heat (up to about 180° C.).

d) For step 6, the ink should exhibit excellent flexibility and elongation to allow the substrate and ink to be stretched to draw ratios (depth:width ratio) as high as about 8:1.

e) For the finished product, the ink should exhibit reasonable scratch resistance, and maintain excellent adhesion to the substrate.

C. Description of a Typical In-Mold-Decoration Process

1) Steps 1-8 of the thermoforming process are completed using polycarbonate as the substrate (typically) resulting in an object as depicted in FIG. 2c.

2) The thermoformed part is then placed into a heated mold on an injection-molding machine.

3) The mold is then clamped shut and hot (about 275-300° C.) molten polycarbonate is injected directly onto the ink or coating surface, flowing across the face of the ink or coating and filling the mold.

4) The injected polycarbonate cools enough to solidify, and the part is removed from the mold resulting in an object as depicted in FIG. 2d.

5) The laminate part is then trimmed to the final shape and stored for assembly into the final product (cellular phone cover, automobile fascia, hockey helmet, etc.).

D. Requirements of the IMD Process

(a) Step 1 requirements of the thermoforming process apply.

(b) Steps 2-3 the ink must have good temperature resistance and not be washed away from the printed substrate by the hot molten polycarbonate as it spreads across the ink surface.

(c) Step 4, the ink must have good adhesion to the injected polycarbonate layer, or the laminate will fall apart.

Radiation curable compositions were produced with components from among the categories: radiation curable urethane (meth)acrylate oligomer, radiation curable monomers and diluents, radical-generating photoinitiators, and additives. Constituents in those categories are along with the weight percentages of each category useful in radiation curable compositions, of the first objective are set forth below. All percentages are by weight based upon the total weight of the composition. All molecular weights are given as number-average molecular weight in units of grams per mole.

1) Radiation Curable Urethane (Meth)acrylate Oligomer (About 5-85%)

This component is generally defined as an acrylate and/or methacrylate functional urethane oligomer with one to four polymerizable acrylate and/or methacrylate groups, and preferably with two polymerization acrylate and/or methacrylate groups. The molecular weight range of the oligomer is about 1,000-20,000 g/mol, preferably about 2,500-15,000 g/mol, and most preferably about 4,000-10,000 g/mol. The oligomer has an elongation at break of greater than about 100%, as measured by tensile testing of a radiation-cured thin free-film of the oligomer, and preferably greater than about 300% elongation at break.

Scheme 1. General Structure for High Elongation Urethane (Meth)acrylate.

CH₂═CH(R₁)—COO—R₂—OCONH—R₃—NHCOO—[Z—OCONH—R₃—NHCO]ₙ—O—R₂—OCO—CH(R₁)═CH₂

where:

R₁=H, CH₃

R₂=CH₂CH₂, CH₂CH(CH₃)CH₂, CH₂CH₂O[CO(CH₂)₅]_{q}, CH₂CH₂CH₂CH₂, CH₂CHCH₃, CH₂CH₂CH₂, CH₂CH₂CH₂CH₂CH₂

n=1 to about 20

q=1 to about 20

R₃=aliphatic, cycloaliphatic, heterocyclic, or aromatic radical with molecular weight about 25-10,000 g/mol

Z=moiety from one or more of: polyesters, polyethers, polyglycols, polycarbonates, polyurethanes, polyolefins; having a number average molecular weight of about 25-10,000 g/mol. wherein said Z moieties have the following formulae:

polyesters: -[A-OCO-B-COO]ₘ-A- or -[E-COO]ₘ-D-[OCO-E]ₘ-

polyethers/polyglycols: -A-[G-O]ₘ-G- or -G-[O-G]ₘ-O-A-O-[G-O]ₘ-G- or -A-

polycarbonates: -J-[OCOO-J]ₘ-

polyurethanes: -L-[OCON-Q-NCOO-L]ₘ-

polyolefins: -Q-[R]ₘQ-

where:

A=linear, branched, or cyclic aliphatic or aromatic radical with a molecular weight of about 14 g/mol-1,000 g/mol based upon C and H, and optionally containing N, O, S, or Si

B=linear, branched, or cyclic aliphatic or aromatic radical with a molecular weight of about 14 g/mol-1,000 g/mol based upon C and H, and optionally containing N, O, S, or Si

D=linear, branched, or cyclic aliphatic or aromatic radical with a molecular weight of about 14 g/mol-1,000 g/mol based upon C and H, and optionally containing N, O, S, or Si

E=linear, branched, or cyclic aliphatic or aromatic radical with a molecular weight of about 14 g/mol-1,000 g/mol based upon C and H, and optionally containing N, O, S, or Si

G=linear, branched, or cyclic aliphatic radical with a molecular weight of about 14 g/mol-1,000 g/mol based upon C and H, and optionally containing N, O, S, or Si

J=linear, branched, or cyclic aliphatic or aromatic radical with a molecular weight of about 14 g/mol-2,000 g/mol based upon C and H, and optionally containing N, O, S, or Si

L=linear, branched, or cyclic aliphatic or aromatic radical with a molecular weight of about 14 g/mol-2,000 g/mol based upon C and H, and optionally containing N, O, S, or Si

Q=linear, branched, or cyclic aliphatic or aromatic radical with a molecular weight of about 14 g/mol-2,000 g/mol based upon C and H, and optionally containing N, O, S, or Si

R=linear, branched, or cyclic aliphatic or aromatic radical with a molecular weight of about 14 g/mol-4,000 g/mol based upon C and H, and optionally containing N, O, S, or Si

m=1 to about 1,000

The oligomer may be prepared by reacting a hydroxy-functional (meth)acrylate component and one or more polyols with one or more isocyanate functional compounds, as defined following, via standard synthetic methods. Examples of components useful in the synthesis of the radiation curable oligomers are given following.

### Hydroxy-Functional (Meth)acrylate Component

Polymerizable (meth)acrylate functionality is incorporated into the said oligomer by reaction of the hydroxy functional group of hydroxy functional (meth)acrylate compound, with molecular weight of about 100 g/mol-1,500 g/mol, with an isocyanate functional compound as defined following. Examples of the hydroxy-functional (meth)acrylate component used to synthesize the oligomer may include: 2-hydroxyethylacrylate (2-HEA), 2-hydroxypropylacrylate (2-HPA), hydroxybutylacrylate (HBA), 2-hydroxyethylmethacrylate (2-HEMA), 2-hydroxypropylmethacrylate (2-HPMA), hydroxybutylmethacrylate (HBMA), and 2-[(1-oxo-2-propenyl)oxy]ethylester, and alkoxylated variants of the same. The preferred embodiments of the oligomer include examples synthesized using 2-hydroxyethylacrylate and/or 2-[(1-oxo-2-propenyl)oxy]ethylester.

### Polyol Component

Examples of the polyol used to synthesize the oligomer include hydroxy-functional oligomers, homopolymers, and/or copolymers from among the following types: aliphatic and/or aromatic polyester, aliphatic and/or aromatic polyether, aliphatic and/or aromatic polycarbonate, aliphatic and/or aromatic polyurethane, and polyolefin. Various polyol types may be incorporated into the oligomer portion of the composition by blending oligomers made with different individual polyol types and/or by making oligomers that include two or more polyols types in a single oligomer backbone. The polyols may be within the molecular weight range about 25-10,000 g/mol, and preferably in the range about 1000-4000 g/mol.

Examples of materials that may comprise a polyester polyol backbone include, but are not limited to, the following polyols: butanediol, propanediol, ethyleneglycol, diethyleneglycol, hexanediol, propyleneglycol, dimer-diol, cyclohexanedimethanol, 2-methylpropanediol, and the like; and include, but are not limited to, the following dibasic acids: adipic acid, phthalic acid, isophthalic acid, terephthalic acid, dodecandioic acid, poly(epsilon-caprolactone), dimer acid, fumaric acid, succinic acid, and the like. Polyester polyols may also optionally be prepared as poly-lactones such as poly(epsilon-caprolactone) by ring-opening polymerization of epsilon-caprolactone, or optionally by copolymerization of epsilon-caprolactone with one or more of the polyols mentioned previously.

Examples of materials that may comprise a polyether polyol homopolymer or copolymer backbone include, but are not limited to, the following: poly(ethylene glycol), poly(propylene glycol), poly(tetrahydrofuran), poly(3-methyl-tetrahydrofuran), poly(bisphenol-A-glycidylether), poly(hexamethyleneglycol), and the like. Hydroxy functional polyols prepared by ring-opening homopolymerization or copolymerization of cyclic ethers such as tetrahydrofuran, ethylene oxide, cyclohexene oxide, and the like may also be used.

Examples of materials that may comprise a polycarbonate polyol backbone include, but are not limited to the following: poly(hexanediol carbonate), poly(butanediol carbonate), poly(ethyleneglycol carbonate), poly(bisphenol-A carbonate), poly(tetrahydrofuran) carbonate, poly(nonanediol carbonate), poly (3-methyl-1,5-pentamethylene carbonate), and the like.

Examples of materials that may comprise a polyurethane polyol backbone include, but are not limited to the following polyols: butanediol, hexanediol, ethyleneglycol, diethyleneglycol, and the like; and may include, but are not limited to, the following isocyanates: hexamethylenediisocyanate, isophorone-diisocyanate, bis(4-isocyanatocyclohexyl)methane, toluene-diisocyanate, diphenylmethane-4,4′-diisocyanate, trimethylhexamethylene diisocyanate, tetramethyl-m-xylene diisocyanate, and the like, as well as isocyanate functional biurets, allophonates, and isocyanurates of the previously listed isocyanates.

A particularly useful combination of polyols in the oligomer synthesis is mixed aliphatic/aromatic polyester polyols with polyether polyol wherein such combinations can be derived by mixing individually prepared oligomers or by using the polyols in combination in an individual extended oligomer.

### Isocyanate Component

The isocyanate functional compound used to synthesize the oligomer may include, but are not limited to, one or more of the following examples of difunctional aromatic and/or aliphatic isocyanates: hexamethylene-diisocyanate (HMDI), isophorone-diisocyanate (IPDI), bis(4-isocyanatocyclohexyl)methane, toluene-diisocyanate (TDI), diphenylmethane-4,4′-diisocyanate (MDI), trimethylhexamethylene diisocyanate, tetramethyl-m-xylene diisocyanate. Particularly useful examples of isocyanates include hexamethylene-diisocyanate (HMDI) and isophorone-diisocyanate (IPDI), which engender flexibility in the radiation curable oligomer. Optionally, isocyanate functional biurets, allophonates, and isocyanurates of the previously listed or similar isocyanates may be used.

2. Radiation Curable Monomers and Diluents (About 0.1-50%)

Radiation curable monomers are useful for adjusting the rheology and viscosity of the radiation curable compositions, modifying the post-cure scratch and abrasion resistance of the radiation curable compositions, modifying the pre-cure and post-cure adhesion characteristics of the radiation curable compositions on various substrates, modifying the chemical resistance of the radiation curable compositions, and modifying the post-cure flexibility of the radiation curable compositions. For the present invention of the overall objective, radiation curable monomers and diluents may be selected from among the group: (meth)acrylate, N-vinylamide, vinylether, vinylester, maleimide, propenylether, and (meth)acrylamide. Particularly useful examples of such diluents for the first objective radiation curable compositions include: isobornylacrylate (IBOA), tricyclodecane mono-methanol acrylate, N-vinylpyrrolidinone, N-vinylcaprolactam, and 1-vinyl-2-piperidinone.

3. Additional Radiation Curable Oligomers (About 0.1-50%)

Incorporation of additional radiation curable oligomers in the inventive radiation curable composition of the first objective can be of benefit to modify the post-cure tensile properties, post-cure hardness and impact resistance, post-cure scratch and abrasion resistance, pre-cure and post-cure chemical resistance, and pre-cure rheology and viscosity of those compositions. Useful oligomers may be selected from among the following types: polyester (meth)acrylate, urethane (meth)acrylate, polyester (meth)acrylamide, urethane (meth)acrylamide, amino-(meth)acrylate, epoxy (meth)acrylate, vinylether, N-vinylamide, vinylester, maleimide, propenylether.

4. Radical-Generating Initiators (About 0-20%)

The compositions of the particular objective of the present invention may be polymerized or cured by exposure to heat after addition of a thermally-activated radical-producing initiator compound, by direct exposure to actinic and/or ionizing radiation without addition of an initiator compound, and/or preferably by exposure to actinic or ionizing radiation after addition of chemical species capable of generating radicals upon exposure to actinic or ionizing radiation. The preferred embodiments of the compositions of the overall objective of the present invention include radical-generating photoinitiator compounds selected from the group: hydrogen-abstraction photoinitiators, cleavage photoinitiators, maleimide-type photoinitiators, and radical-generating cationic photoinitiators, and are cured by exposure to actinic radiation.

5. Additives (About 0-25%)

Various additives may optionally be included in the inventive composition of the particular objective, as may be useful for preparing radiation curable compositions for inks and/or coatings. Examples of particularly useful types of additives include, but are not limited to, the following: acrylated and/or non-acrylated amine synergists, fillers, defoamers, flow agents, pigments, dyes, pigment wetting agents, surfactants, dispersants, matting agents, and non-polymerizable diluents.

6. Fluorinated Compatibilizer (About 0-5%)

Fluorinated surfactants, oligomers and polymers are known in the art to be useful in preparing and compatibilizing polymer/polymer blends particularly during melt-extrusion processing. It has been found in the present invention that some fluoropolymer additives provided synergistic benefits for adhesion when combined in radiation curable compositions with the oligomers and monomers described above. The use of the fluoropolymer additives is not necessary to attain the useful combination of benefits of the invention, but may enhance adhesion in the IMD and other processes. It is postulated that the fluorinated oligomers and/or polymers affect the adhesion benefits by improving wetting of the polymer substrates by the curable composition and by improving wetting of the cured coating or ink composition by the injected thermoplastic during IMD processes. Examples of fluoropolymer additives that are particularly useful in the particular objective of the present invention include: Fluorad™ FC-4430 (3M™ Corporation) and Zonyl® FSG (Dupont Corporation).

7. Polymerizable Monomer Component (About 0.5-60%)

Generally, radiation polymerizable monomers useful to gain adhesion to the injected polycarbonate layer in IMD and IMD laminated articles where the polycarbonate is injected directly onto the cured ink or cured coating surface are selected from those depicted in Scheme 3.

Previous publications in the art (U.S. Pat. No. 5,047,261, U.S. Pat. No. 5,360,836, WO 02/42383 A1) have demonstrated that a number of examples of (meth)acrylate monomers with hetero-atom functionality in linear and/or cyclic configurations exhibit particular utility due to enhanced rates of cure afforded by the monomers alone or in combination with other components in radiation curable compositions. In the present invention, it has been found that examples of (meth)acrylate monomers with hetero-atom functionality in linear and/or cyclic configurations which, in contrast to the claimed utility for examples in the previous patented art, show moderate or slow cure speeds, alone or in combination with other radiation curable components, offer surprising benefits for adhesion in IMD laminate articles. Specifically, examples of the heterocyclic (meth)acrylate compounds that demonstrate the particular utility of enhanced rapid cure rates do not offer the adhesion benefits in IMD laminate articles observed with the slower curing examples. Additionally, N-vinyl functional amides have also been found in the present invention to offer surprising benefit for adhesion in IMD laminate articles.

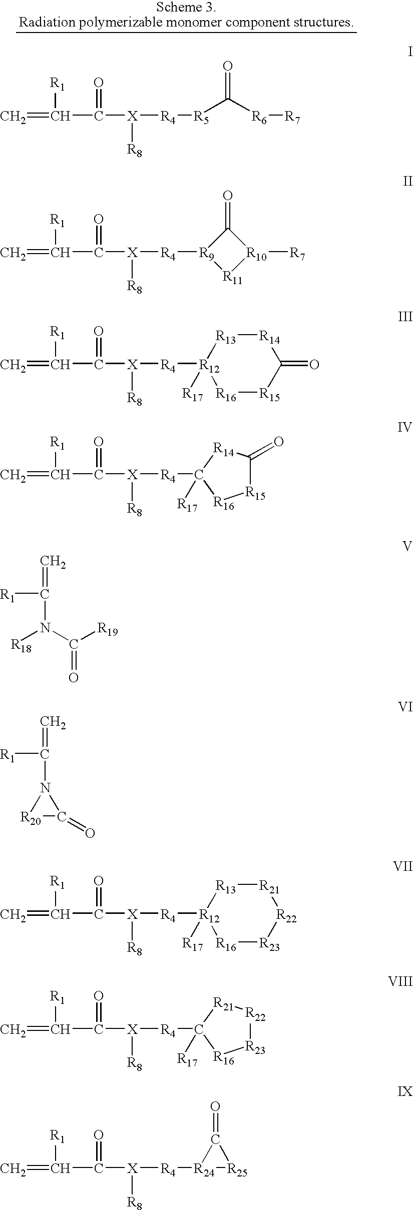

where:

R₁=H, CH₃

X=O, N

R₄=aliphatic or aromatic radical of about 15-1000 g/mol molecular weight containing C, H, and optionally one or more of N, O, S, Si

R₅=O, N, S

R₆=O, N, S

R₇=H, or aliphatic or aromatic radical of about 15-1000 g/mol molecular weight containing C, H, and optionally one or more of N, O, S, Si

R₈=absent when X=O; H, or aliphatic or aromatic radical of about 15-1000 g/mol molecular weight containing C, H, and optionally one or more of N, O, S, Si when X=N

R₉=N

R₁₀=N

R₁₁=aliphatic or aromatic radical of about 15-1000 g/mol molecular weight containing C, H, and optionally one or more of N, O, S, Si

R₁₂=O, N

R₁₃=aliphatic radical of about C₁-C₁₀ length optionally containing N, O, or S

R₁₄=O, NH, S

R₁₅=O, NH, S

R₁₆=aliphatic radical of about C₁-C₁₀ length optionally containing N, O, or S

R₁₇=H, or aliphatic or aromatic radical of about 15-1000 g/mol molecular weight containing C, H, and optionally one or more of N, O, S, Si

R₁₈=H, or aliphatic or aromatic radical with molecular weight about 15-1,000 g/mol

R₁₉=H, or aliphatic or aromatic radical with molecular weight about 15-1,000 g/mol

R₂₀=branched or straight-chained aliphatic, aromatic, or heterocyclic radical with molecular weight about 14-1,000 g/mol.

R₂₁=O, S, NR₁₇

R₂₂=CHR₁₇

R₂₃=O, S, NR₁₇

R₂₄=N

R₂₅=aliphatic radical of about C₁-C₁₀ length optionally containing N, O, or S

There are now described possible modes of action from whence the surprising utility may be derived for the particular objective of the present invention. It is postulated that the slow cure rates of the heterocyclic (meth)acrylate compounds used in the radiation curable compositions of this invention, as observed in separate kinetic experiments, allows and causes consequential amounts of residual un-cured heterocylic monomer to remain in the cured coatings and/or inks made from compositions containing the monomer(s). Upon subjection to high temperature and/or high pressure during the injection molding stage of the IMD process, the residual un-cured monomer may migrate to the interface of the cured ink/coating and the injected molten polycarbonate, as observed by detection of such monomers at the ink/injected polycarbonate interface of peeled IMD laminate articles. This migration may effect benefit for adhesion in several possible ways: 1) migration of the uncured monomer through the surface of the cured ink may create pores in the ink surface which may be partially or completely filled by molten polycarbonate, allowing penetration of the polycarbonate into the ink layers resulting in entanglement and enhanced physical adhesion upon cooling of the polycarbonate, 2) uncured monomer at the interface may partially solvate and swell the surface layers of the ink, allowing interpenetration of polycarbonate resin into the ink surface, again creating physical adhesion upon cooling of the polycarbonate, and/or 3) the uncured monomer at the interface may partially solvate the molten polycarbonate allowing better wetting of the ink surface by the molten polycarbonate and thereby enhancing adhesion in the cooled laminated article.

The heterocyclic functionality of the particular polymerizable monomer component in the compositions of the present invention very likely affords enhancements of postulated modes 2) and 3) above due to enhanced dilution and salvation effects. Similar kinetic data have been observed for N-vinylamide monomers (depicted in structures V and VI in Scheme 3), and similar modes of action are postulated to occur when examples of N-vinylamides are included in the radiation curable compositions. Particularly useful embodiments of the polymerizable monomer component include: (2-Oxo-1,3-dioxolan-4-yl)methyl methacrylate known as GMA carbonate, and N-vinylpyrrolidinone. Heterocyclic functional radiation curable monomers that showed very high rates of cure did not show the adhesion benefits in inks and coatings for IMD.

### General Process for Preparing and Printing an IMD Screen-Ink Formulation

1) Components employed in examples which follow included those selected from the following categories:

Oligomer—provides the chemical backbone of the ink and primarily determines the cured ink's flexibility, weatherability, durability, etc., and affects the ink's viscosity and adhesion

Monomer—used to modify the viscosity of the ink, can increase or decrease the cured ink's flexibility, chemical resistance, scratch and abrasion resistance, and adhesion to the substrate

Adhesion promoters—used to enhance adhesion to difficult substrates including plastics; usually amine, amide, or urethane functional. Also affect cure-speed and pigment wetting and dispersion.

Pigments—provide color base for the ink; usually variation on five basic colors: cyan, magenta, yellow, white, black; used at about 5-50% by weight in the final ink

Defoamer and other additives—defoamer is added to reduce tendency of the ink to foam under shear conditions during ink making and printing; other additives such as surfactants, pigment dispersants, flow-aids are added to tune the quality and printing characteristics of the inks

Fillers—added to modify the scratch and abrasion resistance, increase or decrease gloss (shine), increase or decrease viscosity and ink flow, decrease cost of the ink; include aluminum oxide, silica, talc, etc.

Photoinitiator—initiates curing of the UV-ink on exposure to radiation

2) The components of the pre-mill ink formulation are mixed together including the oligomer, some of the monomer portion, pigment, defoamer, and some additives such as dispersing aid

3) The pre-mill formulation is run through a 3-roll mill that grinds the pigment particles into small dispersible pieces and disperses the pigment evenly into the oligomer/monomer pre-mill formulation to make a pigment dispersion.

4) The pigment dispersion is then diluted with additional monomer, and the final additives, fillers, photinitiator, etc. are added and evenly dispersed into the ink.

5) The ink is then diluted as appropriate to reach the desired viscosity for printing.

6) The final ink is screen-printed as follows

a) The ink is placed in a line on one side of the screen using an ink-knife.

b) The ink is then spread across the image area of the screen under pressure using a squeegee, and the strokes are repeated to get the desired ink thickness.

c) The printed substrate is then cured by passing under ultraviolet light on a conveyor belt.

7) Steps a-c are then repeated for as many additional colors as necessary, using different image screens as necessary.

### EXAMPLES OF INKS AND CLEAR COATINGS

General Process

Inks and/or clear coating compositions were prepared via typical methods known to those skilled in the art. The inks and coatings contained the following types of components: oligomers, monomers, photoinitiators, and additives. Definition of the components used in the examples are given below. Samples for injection molding and adhesion testing were printed by hand on 8.5×11″ Lexano® sheets using a Durometer A70 squeegee, a 355/34 pw mesh screen with 15-17N/cm tension, and 2-3 passes through a Fusion UV-Systems curing unit equipped with two 600-H bulbs at about 80-120 ft/min. Samples for thermoforming testing were printed by hand on 14×14″ Lexano® sheets using a Durometer A70 squeegee, a 390/31 pw mesh screen, with 17-19N/cm tension, and two passes through a Fusion UV-Systems curing unit equipped with two 600-H bulbs at about 80 ft/min.

Oligomers

General Process for Synthesizing the Urethane Acrylate Oligomers:

Diisocyanate, catalyst, and stabilizer are charged to the reactor. The alkoxy acrylate is mixed with an inhibitor and the mixture is added slowly to a stirring solution in the reactor. The reactor mixture is then held at about 65° C. for about 1 hour. The preheated polyol or polyol mixture is charged to the stirring reactor mixture over about 1-2 hours, maintaining temperature less than about 93° C. The mixture is then stirred and held at about 88-93° C. until the reaction is complete. The product is then transferred from the reactor to storage containers and allowed to cool.

RX04916: about 7,500 g/mol urethane acrylate oligomer based upon 2-hydroxyethyl acrylate, isophorone diisocyanate, and hexanediol-adipate-isophthalate polyester. Elongation at break ˜320%.

RX04918: about 4,475 g/mol urethane acrylate oligomer based upon 2-[(1-oxo-2-propenyl)oxy]ethylester, isophorone diisocyanate, hexanediol-adipate-isophthalate polyester polyol, and hexandiolcarbonate. Elongation at break ˜230%.

RX04935: about 7,500 g/mol urethane acrylate oligomer based upon 2-hydroxyethyl acrylate, isophorone diisocyanate, and hexanediol-adipate-isophthalate polyester and diluted with 20% isobornylacrylate by weight. Elongation at break ˜420%.

RX04939: about 8,700 g/mol urethane acrylate oligomer based upon 2-hydroxyethyl acrylate, isophorone diisocyanate, hexanediol-adipate-isophthalate polyester polyol, and poly(tetrahydrofuran) polyol and diluted with about 30% isobornylacrylate by weight. Elongation at break ˜550%.

RX04944: about 9,270 g/mol urethane acrylate oligomer based upon 2-hydroxyethyl acrylate, isophorone diisocyanate, hexanediol-adipate-isophthalate polyester polyol, and poly(tetrahydrofuran) polyol and diluted with about 27.5% isobornylacrylate by weight. Elongation at break ˜510%.

RX04945: about 9,850 g/mol urethane acrylate oligomer based upon 2-hydroxyethyl acrylate, isophorone diisocyanate, hexanediol-adipate-isophthalate polyester polyol, and poly(tetrahydrofuran) polyol and diluted with about 30% isobornylacrylate by weight. Elongation at break ˜550%.

RX04948: about 9,270 g/mol urethane acrylate oligomer based upon 2-hydroxyethyl acrylate, isophorone diisocyanate, hexanediol-adipate-isophthalate polyester polyol, and poly(tetrahydrofuran) polyol and diluted with about 27.5% isobornylacrylate by weight.

RX04952: about 7,130 g/mol urethane acrylate oligomer based upon 2-hydroxyethyl acrylate, isophorone diisocyanate, and hexanediol-adipate-isophthalate polyester polyol and diluted with about 20% isobornylacrylate by weight.

RX04957: about 9,920 g/mol urethane acrylate oligomer based upon 2-hydroxyethyl acrylate, isophorone diisocyanate, hexanediol-adipate-isophthalate polyester polyol, and poly(tetramethylene ether) polyol and diluted with about 30% isobornylacrylate by weight.

RX04959: about 8,090 g/mol urethane acrylate oligomer based upon 2-hydroxyethyl acrylate, isophorone diisocyanate, hexanediol-adipate-isophthalate polyester polyol, and poly(tetramethylene ether) polyol and diluted with about 24.5% isobornylacrylate by weight.

RX04960: about 7,780 g/mol urethane acrylate oligomer based upon 2-hydroxyethyl acrylate, isophorone diisocyanate, hexanediol-adipate-isophthalate polyester polyol, and poly(tetramethylene ether) polyol and diluted with about 23% isobornylacrylate by weight.

Ebecryl® 8411 (UCB Chemicals): aliphatic polyurethane acrylate.

IRR 381 (UCB Chemicals): 2,700 g/mol urethane acrylate oligomer.

Polymerizable Diluting Monomers

IBOA (UCB Chemicals) isobornyl acrylate.

RX03593: experimental acrylate monomer.

Additives

Ebecryl® 7100 (UCB Chemicals): amine-functional acrylate monomer to promote adhesion

TEGO® Foamex N (Goldschmidt Chemical Corporation), used as defoamer

Fluorinated Compatibilizers

PolyFox™ TB (Omnova)

Zonyl® FSG (Dupont)

Zonyl® FSN (Dupont)

Fluorad™ FC-4430 (3M™ Corporation)

Polymerizable Monomer Components

RD RX/201: (2-Oxo-1,3-dioxolan-4-yl)methyl methacrylate, known as GMA carbonate

NVP: N-vinylpyrrolidinone.

### EXAMPLES

### Example 1

A UV-polymerizable ink composition was prepared via the process outlined previously being composed of: 31.54 g RX04935 (polyester-based urethane acrylate), 15.14 g RX04945 (polyester/polyether urethane acrylate), 20.81 g IBOA (UCB Chemicals), 8.88 g RD RX/201, 3.78 g NVP, 7.57 g Ebecryl® 7100 (UCB Chemicals), 0.50 g TEGO® Foamex N (Goldschmidt Chemical Corporation), 0.53 g Zonyl® FSG (Dupont), 1.89 g magenta pigment, and 9.34 g Viacure DX/LX photoinitiator blend (UCB Chemicals). The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

Inks in five colors (cyan, magenta, yellow, black, white) were prepared based upon this oligomer/monomer/additive composition. Prints for thermoforming evaluation were made by hand on 14×14″ Lexan® sheets using a Durometer A70 squeegee, a 390/34 pw mesh screen with 15-17N/cm tension, and 2-3 passes through a Fusion UV-Systems curing unit equipped with two 600-H bulbs at about 80-120 ft/min. The inks in all colors showed excellent adhesion to the Lexan® substrate, little to no surface tack, and exhibited excellent thermoforming characteristics at draw ratios from 1:1 to 8:1.

### Example 2

A UV-polymerizable ink composition was prepared via the process outlined previously being composed of: 6.08 g RX04935 (polyester-based urethane acrylate), 43.24 g RX04944 (polyester/polyether based urethane acrylate), 18.72 g IBOA (UCB Chemicals), 16.22 g RD RX/201, 5.41 g Ebecryl® 7100 (UCB Chemicals), 0.54 g TEGO® Foamex N (Goldschmidt Chemical Corporation), 3.04 g magenta pigment, and 6.76 g Viacure DX/LX (UCB Chemicals). The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The ink showed excellent adhesion to the Lexan® substrate and was not tacky to touch. The ink was then tested for adhesion in IMD laminates. Results are given in Table 1.

### Example 3

A UV-polymerizable clear-coat composition was prepared via the process outlined previously being composed of: 24.18 g RX04918 (polyester/polycarbonate based urethane acrylate), 11.38 IRR 381 (polyester based urethane acrylate), 32.72 g RX03593, 22.76 g RD RX/201, 4.27 g Ebecryl® 7100 (UCB Chemicals), 0.43 g TEGO® Foamex N (Goldschmidt Chemical Corporation), and 4.27 g Darocur® 1173 (Ciba® Specialty Chemicals). The clear coat was printed in two layers on-top of a standard magenta ink which was composed of: 63.91 g Ebecryl® 8411, 5.46 g IBOA (UCB Chemicals), 13 g NVP, 5 g Ebecryl® 7100 (UCB Chemicals), 0.18 g TEGO® Foamex N (Goldschmidt Chemical Corporation), 4.46 g magenta pigment, and 8 g Viacure DX/LX . The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The clear coat was then printed in two layers on top of the ink following the same procedure. The print showed excellent adhesion to the Lexan® substrate and was slightly tacky to touch. The clear-coated ink was then tested for adhesion in IMD laminates. Results are given in Table 1.

### Example 4

A UV-polymerizable ink composition was prepared via the process outlined previously being composed of: 40 g RX04935 (polyester-based urethane acrylate), 29.2 g IBOA (UCB Chemicals), 11.6 g RD RX/201, 2.8 g Ebecryl® 7100 (UCB Chemicals), 0.4 g TEGO® Foamex N (Goldschmidt Chemical Corporation), 4 g magenta pigment, 10 g Viacure DX/LX, and 2 g Darocur® 1173 (Ciba® Specialty Chemicals). The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The ink showed excellent adhesion to the Lexan® substrate and was slightly tacky to touch. The ink was then tested for adhesion in IMD laminates. Results are given in Table 1.

### Example 5

A UV-polymerizable ink composition was prepared via the process outlined previously being composed of: 23.87 g RX04935 (polyester-based urethane acrylate), 19.89 g RX04939 (polyester/polyether urethane acrylate), 21.88 g IBOA (UCB Chemicals), 13.26 g RD RX/201, 3.9 g NVP, 6.63 g Ebecryl® 7100 (UCB Chemicals), 0.53 g TEGO® Foamex N (Goldschmidt Chemical Corporation), 1.33 g TS-100 (Degussa), 1.99 g magenta pigment, and 6.63 g Viacure DX/LX photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

Inks in five colors (cyan, magenta, yellow, black, white) were prepared based upon this oligomer/monomer/additive composition. Prints for thermoforming evaluation were made by hand on 14×14″ Lexan® sheets using a Durometer A70 squeegee, a 390/31 pw mesh screen with 15-17N/cm tension, and 2-3 passes through a Fusion UV-Systems curing unit equipped with two 600-H bulbs at about 80-120 ft/min. The inks in all colors showed excellent adhesion to the Lexan® substrate, little to no surface tack, and exhibited excellent thermoforming characteristics at draw ratios from 1:1 to 8:1.

### Example 6

A UV-polymerizable clear-coat composition was prepared via the process outlined previously being composed of: 40.76 g RX04918 (polyester/polycarbonate based urethane acrylate), 19.88 g RX03593, 24.85 g RD RX/201, 4.97 g NVP, 4.97 g Ebecryl® 7100 (UCB Chemicals), 0.60 g TEGO® Foamex N (Goldschmidt Chemical Corporation), and 3.98 g Darocur® 1173 (Ciba® Specialty Chemicals). The clear coat was printed in two layers on-top of a standard magenta ink which was composed of: 63.91 g Ebecryl® 8411, 5.46 g IBOA (UCB Chemicals), 13 g NVP, 5 g Ebecryl® 7100 (UCB Chemicals), 0.18 g TEGO® Foamex N (Goldschmidt Chemical Corporation), 4.46 g magenta pigment, and 8 g Viacure DX/LX . The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The clear coat was then printed in two layers on top of the ink following the same procedure. The print showed excellent adhesion to the Lexan® substrate and was slightly tacky to touch. The clear-coated ink was then tested for adhesion in IMD laminates. Results are given in Table 1.

### Example 7

A UV-polymerizable ink composition was prepared via the process outlined previously being composed of: 45.90 g RX04959 (polyester/polyether-based urethane acrylate), 15.23 g IBOA (UCB Chemicals), 13.87 g RD RX/201, 4.17 g NVP, 7.29 g Ebecryl® 7100 (UCB Chemicals), 0.52 g TEGO® Foamex N (Goldschmidt Chemical Corporation), 0.52 g TS-100 (Degussa), 4.17 g magenta pigment, and 8.33 g Viacure DX/LX photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

Inks in five colors (cyan, magenta, yellow, black, white) were prepared based upon this oligomer/monomer/additive composition. Prints for thermoforming evaluation were made by hand on 14×14″ Lexan® sheets using a Durometer A70 squeegee, a 390/31 pw mesh screen with 15-17N/cm tension, and 2-3 passes through a Fusion UV-Systems curing unit equipped with two 600-H bulbs at about 80-120 ft/min. The inks in all colors showed excellent adhesion to the Lexan® substrate, little to no surface tack, and exhibited excellent thermoforming characteristics at draw ratios from 1:1 to 8:1.

### Example 8

A UV-polymerizable ink composition was prepared via the process outlined previously being composed of: 47.69 g RX04960 (polyester/polyether-based urethane acrylate), 18.13 g IBOA (UCB Chemicals), 9.08 g RD RX/201, 4.08 g NVP, 8.16 g Ebecryl® 7100 (UCB Chemicals), 0.51 g TEGO® Foamex N (Goldschmidt Chemical Corporation), 0.1 g Fluorad™ FC-4430 (3M™), 4.08 g magenta pigment, and 8.16 g Viacure DX/LX photoinitiator blend . The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

Inks in five colors (cyan, magenta, yellow, black, white) were prepared based upon this oligomer/monomer/additive composition. Prints for thermoforming evaluation were made by hand on 14×14″ Lexan® sheets using a Durometer A70 squeegee, a 390/31 pw mesh screen with 15-17N/cm tension, and 2-3 passes through a Fusion UV-Systems curing unit equipped with two 600-H bulbs at about 80-120 ft/min. The inks in all colors showed excellent adhesion to the Lexano substrate, little to no surface tack, and exhibited excellent thermoforming characteristics at draw ratios from 1:1 to 8:1.

### Example 9

A UV-polymerizable clear-coat composition was prepared via the process outlined previously being composed of: 40.76 g RX04918 (polyester/polycarbonate based urethane acrylate), 24.85 g RX03593, 24.85 g RD RX/201, 4.97 g Ebecryl® 7100 (UCB Chemicals), 0.60 g TEGO® Foamex N (Goldschmidt Chemical Corporation), and 3.98 g Darocur® 1173 (Ciba® Specialty Chemicals). The clear coat was printed in two layers on-top of a standard magenta ink which was composed of: 63.91 g Ebecryl® 8411, 5.46 g IBOA (UCB Chemicals), 13 g NVP, 5 g Ebecryl® 7100 (UCB Chemicals), 0.18 g TEGO® Foamex N (Goldschmidt Chemical Corporation), 4.46 g magenta pigment, and 8 g Viacure DX/LX. The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The clear coat was then printed in two layers on top of the ink following the same procedure. The print showed excellent adhesion to the Lexan® substrate and was slightly tacky to touch. The clear-coated ink was then tested for adhesion in IMD laminates. Results are given in Table 1.

### Example 10

A UV-polymerizable ink composition was prepared via the process outlined previously being composed of: 44.06 g RX04959 (polyester/polyether-based urethane acrylate), 18.62 g IBOA (UCB Chemicals), 13.32 g RD RX/201, 4 g NVP, 7 g Ebecryl® 7100 (UCB Chemicals), 0.4 g TEGO® Foamex N (Goldschmidt Chemical Corporation), 0.2 g Fluorad™ FC-4430 (3M™), 4 g magenta pigment, and 8 g Viacure DX/LX photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

### Example 11

A UV-polymerizable ink composition was prepared via the process outlined previously being composed of: 40.80 g RX04952 (polyester-based urethane acrylate), 26.80 g IBOA (UCB Chemicals), 11.80 g RD RX/201, 6 g Ebecryl® 7100 (UCB Chemicals), 0.4 g TEGO® Foamex N (Goldschmidt Chemical Corporation), 4 g magenta pigment, and 10.2 g Viacure DX/LX photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

### Example 12

A UV-polymerizable clear-coat composition was prepared via the process outlined previously being composed of: 30.92 g RX04918 (polyester/polycarbonate based urethane acrylate), 9.45 IRR 381 (polyester based urethane acrylate), 24.73 g IBOA (UCB Chemicals), 5.30 g RX03593, 17.67 g RD RX/201, 3.53 g NVP, 4.42 g Ebecryl® 7100 (UCB Chemicals), 0.44 g TEGO® Foamex N (Goldschmidt Chemical Corporation), and 3.53 g Darocur® 1173 (Ciba® Specialty Chemicals). The clear coat was printed in two layers on-top of a standard magenta ink which was composed of: 63.91 g Ebecryl® 8411, 5.46 g IBOA (UCB Chemicals), 13 g NVP, 5 g Ebecryl® 7100 (UCB Chemicals), 0.18 g TEGO® Foamex N (Goldschmidt Chemical Corporation), 4.46 g magenta pigment, and 8 g Viacure DX/LX. The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The clear coat was then printed in two layers on top of the ink following the same procedure. The print showed excellent adhesion to the Lexan® substrate and was somewhat tacky to touch. The clear-coated ink was then tested for adhesion in IMD laminates. Results are given in Table 1.

### Example 13

A UV-polymerizable ink composition was prepared via the process outlined previously being composed of: 31.60 g RX04935 (polyester-based urethane acrylate), 15.17 g RX04945 (polyester/polyether urethane acrylate), 20.85 g IBOA (UCB Chemicals), 8.90 g RD RX/201, 3.79 g NVP, 7.58 g Ebecryl® 7100 (UCB Chemicals), 0.51 g TEGO® Foamex N (Goldschmidt Chemical Corporation), 0.36 g Fluorad™ FC-4430 (3M™), 1.90 g magenta pigment, and 9.36 g Viacure DX/LX photoinitiator blend . The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was tested for adhesion in IMD laminates. Results are given in Table 1.

Inks in five colors (cyan, magenta, yellow, black, white) were prepared based upon this oligomer/monomer/additive composition. Prints for thermoforming evaluation were made by hand on 14×14″ Lexan® sheets using a Durometer A70 squeegee, a 390/31 pw mesh screen with 15-17N/cm tension, and 2-3 passes through a Fusion UV-Systems curing unit equipped with two 600-H bulbs at about 80-120 ft/min. The inks in all colors showed excellent adhesion to the Lexan® substrate, little to no surface tack, and exhibited excellent thermoforming characteristics at draw ratios from 1:1 to 8:1.

### Example 14

A UV-polymerizable clear-coat composition was prepared via the process outlined previously being composed of: 42.91 g RX04916 (polyester-based urethane acrylate), 22.44 g IBOA (UCB Chemicals), 22.44 g RD RX/201, 3.59 g NVP, 4.49 g Ebecryl® 7100 (UCB Chemicals), 0.54 g TEGO® Foamex N (Goldschmidt Chemical Corporation), and 3.59 g Darocur® 1173 (Ciba® Specialty Chemicals). The clear coat was printed in two layers on-top of a standard magenta ink which was composed of: 63.91 g Ebecryl® 8411, 5.46 g IBOA (UCB Chemicals), 13 g NVP, 5 g Ebecryl® 7100 (UCB Chemicals), 0.18 g TEGO® Foamex N (Goldschmidt Chemical Corporation), 4.46 g magenta pigment, and 8 g Viacure DX/LX. The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The clear coat was then printed in two layers on top of the ink following the same procedure. The print showed excellent adhesion to the Lexan® substrate and was not tacky to touch. The clear-coated ink was then tested for adhesion in IMD laminates. Results are given in Table 1.

### Example 15

A UV-polymerizable ink composition was prepared via the process outlined previously being composed of: 23.90 g RX04952 (polyester-based urethane acrylate), 19.90 g RX04957 (polyester/polyether-based urethane acrylate), 10.20 g IBOA (UCB Chemicals), 25 g RD RX/201, 4 g NVP, 6.60 g Ebecryl® 7100 (UCB Chemicals), 0.5 g TEGO® Foamex N (Goldschmidt Chemical Corporation), 2 g magenta pigment, and 6.6 g Viacure DX/LX photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

TABLE 1
Results from adhesion testing to various IMD injection-molded
polycarbonate substrates.

| | Lexan ® SP 1010 | Lexan ® SP 1010R |
|---|---|---|
| Example 1 | Not tested | Good adhesion |
| Example 2 | Not tested | Good adhesion |
| Example 3 | Some adhesion | Not tested |
| Example 4 | Not tested | Good adhesion |
| Example 5 | Not tested | Good adhesion |
| Example 6 | Some adhesion | Not tested |
| Example 7 | Not tested | Good adhesion |
| Example 8 | Not tested | Good adhesion |
| Example 9 | Some adhesion | Not tested |
| Example 10 | Not tested | Good adhesion |
| Example 11 | Not tested | Some adhesion |
| Example 12 | Some adhesion | Not tested |
| Example 13 | Not tested | Good adhesion |
| Example 14 | Good adhesion | Not tested |
| Example 15 | Not tested | Good adhesion |

### Example 16

A UV-polymerizable ink composition was prepared via the process outlined previously being composed of: 43.03 g RX04948 (polyester/polyether-based urethane acrylate), 34.97 g IBOA (UCB Chemicals), 2 g NVP, 7 g Ebecryl® 7100 (UCB Chemicals), 0.7 g TEGO® Foamex N (Goldschmidt Chemical Corporation), 0.3 g TEGO® RAD 2250 (Goldschmidt Chemical Corporation), 1.5 g silica, 4.5 g magenta pigment, and 6 g Viacure DX. The ink was printed by hand in two layers using Durometer A70 squeegee through a 355/34 pw mesh screen with 17-19N/cm tension, and cured in two passes through a Fusion UV Systems curing unit with two 600-H bulbs at 85 ft/min. The ink showed excellent adhesion and good thermoforming characteristics on the following substrates: polystyrene, Lexan® SP 8010 polycarbonate, polyethylene terephthalate-G of two thicknesses: 4 mm and 500 microns, polyethylene terephthalate, and rigid PVC without any surface treatment.

Surface tack and blocking characteristics of the ink were tested by making a stack composed of one 1.5×1.5″ sample of each of the printed substrates stacked front to back. A cover sheet of polycarbonate and a 1 kg weight was placed on top of the stack with the force applied to the face of the printed samples. The stack was then placed at 25° C. at 48% relative humidity for 24 hours and the evaluated for tack and sticking. This test was then repeated at 35, 45, 55, and 65° C. None of the samples showed any increase in surface tack or tendency to stick to or transfer to the bottom of the substrate above it.

### Example 17

A UV-polymerizable ink composition was prepared via the process outlined previously being composed of: 43.73 g RX04948 (polyester/polyether-based urethane acrylate), 34.77 g IBOA (UCB Chemicals), 2 g NVP, 7 g Ebecryl® 7100 (UCB Chemicals), 0.7 g TEGO® Foamex N (Goldschmidt Chemical Corporation), 0.3 g TEGO® RAD 2250 (Goldschmidt Chemical Corporation), 1.5 g silica, 4 g cyan pigment, and 6 g Viacure DX . The ink was printed by hand in two layers using Durometer A70 squeegee through a 355/34 pw mesh screen with 17-19N/cm tension, and cured in two passes through a Fusion UV Systems curing unit with two 600-H bulbs at 85 ft/min. The ink showed excellent adhesion and good thermoforming characteristics on the following substrates: polystyrene, Lexan® SP 8010 polycarbonate, polyethylene terephthalate-G of two thicknesses: 4 mm and 500 microns, polyethylene terephthalate, and rigid PVC without any surface treatment. The cured ink was not tacky to touch.

### Example 18

A UV-polymerizable ink composition was prepared via the process outlined previously being composed of: 43.73 g RX04948 (polyester/polyether-based urethane acrylate), 34.27 g IBOA (UCB Chemicals), 2 g NVP, 7 g Ebecryl® 7100 (UCB Chemicals), 0.7 g TEGO® Foamex N (Goldschmidt Chemical Corporation), 0.3 g TEGO® RAD 2250 (Goldschmidt Chemical Corporation), 1 g silica, 5 g yellow pigment, and 6 g Viacure DX. The ink was printed by hand in two layers using Durometer A70 squeegee through a 355/34 pw mesh screen with 17-19N/cm tension, and cured in two passes through a Fusion UV Systems curing unit with two 600-H bulbs at 85 ft/min. The ink showed excellent adhesion and good thermoforming characteristics on the following substrates: polystyrene, Lexan® SP 8010 polycarbonate, polyethylene terephthalate-G of two thicknesses: 4 mm and 500 microns, polyethylene terephthalate, and rigid PVC without any surface treatment. The cured ink was not tacky to touch.

### Example 19

A UV-polymerizable ink composition was prepared via the process outlined previously being composed of: 43.03 g RX04948 (polyester/polyether-based urethane acrylate), 35.47 g IBOA (UCB Chemicals), 2 g NVP, 7 g Ebecryl® 7100 (UCB Chemicals), 0.7 g TEGO® Foamex N (Goldschmidt Chemical Corporation), 0.3 g TEGO® RAD 2250 (Goldschmidt Chemical Corporation), 1.5 g silica, 4 g black pigment, and 6 g Viacure DX. The ink was printed by hand in two layers using Durometer A70 squeegee through a 355/34 pw mesh screen with 17-19N/cm tension, and cured in two passes through a Fusion UV Systems curing unit with two 600-H bulbs at 85 ft/min. The ink showed excellent adhesion and good thermoforming characteristics on the following substrates: polystyrene, Lexan® SP 8010 polycarbonate, polyethylene terephthalate-G of two thicknesses: 4 mm and 500 microns, polyethylene terephthalate, and rigid PVC without any surface treatment. The cured ink was not tacky to touch.

### Example 20

A UV-polymerizable ink composition was prepared via the process outlined previously being composed of: 26.81 g RX04948 (polyester/polyether-based urethane acrylate), 21.19 g IBOA (UCB Chemicals), 2 g NVP, 7 g Ebecryl® 7100 (UCB Chemicals), 0.7 g TEGO® Foamex N (Goldschmidt Chemical Corporation), 0.3 g TEGO® RAD 2250 (Goldschmidt Chemical Corporation), 36 g white pigment, and 6 g Viacure LX . The ink was printed by hand in two layers using Durometer A70 squeegee through a 355/34 pw mesh screen with 17-19N/cm tension, and cured in two passes through a Fusion UV Systems curing unit with two 600-H bulbs at 85 ft/min. The ink showed excellent adhesion and good thermoforming characteristics on the following substrates: polystyrene, Lexan® SP 8010 polycarbonate, polyethylene terephthalate-G of two thicknesses: 4 mm and 500 microns, polyethylene terephthalate, and rigid PVC without any surface treatment. The cured ink was not tacky to touch.

We claim:

1. A polymerizable coating composition comprising:
a) about 5-85% by weight of a urethane (meth)acrylate oligomer as depicted below, or a mixture of such oligomers, wherein the polymerizable oligomer or oligomer mixture shows percent elongation at break greater than about 300% and a number average molecular weight of about 1,000-20,000 g/mol, said oligomer having the formula:
CH₂═CH(R₁)—COO—R₂—OCONH—R₃—NHCOO—[Z—OCONH—R₃—NHCO]ₙ—O—R₂—OCO—CH(R₁)═CH₂
where:
R₁=H, CH₃
R₂=CH₂CH₂, CH₂CH(CH₃)CH₂, CH₂CH₂O[CO(CH₂)₅]_{q}, CH₂CH₂CH₂CH₂, CH₂CHCH₃, CH₂CH₂CH₂, CH₂CH₂CH₂CH₂CH₂
n=1 to about 20
q=1 to about 20
R₃=aliphatic, cycloaliphatic, heterocyclic, or aromatic radical with molecular weight about 25-10,000 g/mol
Z=moiety from one or more of: polyesters, polyethers, polyglycols, polycarbonates, polyurethanes, polyolefins; having a number average molecular weight of about 25-10,000 g/mol, wherein said Z moieties have the following formulae:
polyesters: -[A-OCO-B-COO]ₘ-A- or -[E-COO]ₘ-D-[OCO-E]ₘ-
polyethers/polyglycols: -A-[G-O]ₘ-G- or -G-[O-G]ₘ-O-A-O-[G-O]ₘ-G- or -A-
polycarbonates: -J-[OCOO-J]ₘ-
polyurethanes: -L-[OCON-Q-NCOO-L]ₘ-
polyolefins: -Q-[R]ₘ-Q-
where:
A=linear, branched, or cyclic aliphatic or aromatic radical with a molecular weight of about 14 g/mol-1,000 g/mol based upon C and H, and optionally containing N, O, S, or Si
B=linear, branched, or cyclic aliphatic or aromatic radical with a molecular weight of about 14 g/mol-1,000 g/mol based upon C and H, and optionally containing N, O, S, or Si
D=linear, branched, or cyclic aliphatic or aromatic radical with a molecular weight of about 14 g/mol-1,000 g/mol based upon C and H, and optionally containing N, O, S, or Si
E=linear, branched, or cyclic aliphatic or aromatic radical with a molecular weight of about 14 g/mol-1,000 g/mol based upon C and H, and optionally containing N, O, S, or Si
G=linear, branched, or cyclic aliphatic radical with a molecular weight of about 14 g/mol -1,000 g/mol based upon C and H, and optionally containing N, O, S, or Si
J=linear, branched, or cyclic aliphatic or aromatic radical with a molecular weight of about 14 g/mol-2,000 g/mol based upon C and H, and optionally containing N, O, S, or Si
L=linear, branched, or cyclic aliphatic or aromatic radical with a molecular weight of about 14 g/mol-2,000 g/mol based upon C and H, and optionally containing N, O, S, or Si
Q=linear, branched, or cyclic aliphatic or aromatic radical with a molecular weight of about 14 g/mol-2,000 g/mol based upon C and H, and optionally containing N, O, S, or Si
R=linear, branched, or cyclic aliphatic or aromatic radical with a molecular weight of about 14 g/mol-4,000 g/mol based upon C and H, and optionally containing N, O, S, or Si
m=1 to about 1,000,
b. about 0.1-50% by weight of a polymerizable diluting monomer or mixture thereof selected from the group consisting of: (meth)acrylate, (meth)acrylamide, vinylether, vinylester, N-vinylamide, propenylether, maleimide, maleate, or fumarate, and
c. about 0.1-50% by weight of additional polymerizable oligomer selected from the group consisting of: urethane (meth)acrylate, polyester (meth)acrylate, urea (meth)acrylate, vinylether, propenylether, maleimide, vinylester, epoxide, and
d. about 0-20% by weight of a compound or mixture of such compounds which may generate radicals capable of initiating the curing reactions of the curable composition and which may be activated by one or more methods selected from the group consisting of: exposure to actinic radiation, exposure to ionizing radiation, exposure to heat, and
e. about 0-25% by weight of other additives selected from the group consisting of amines, defoamers, flow aids, fillers, surfactants, and adhesion promoters, and
f. about 0-5% by weight of a fluorinated compatibilizer;
wherein such a composition provides, upon curing by ionizing and/or actinic radiation, a coating exhibiting the following characteristics in combination: high flexibility, low post-cure surface tackiness, low shrinkage upon cure, and good adhesion to polymeric substrates.

2. The polymerizable coating composition of claim 1 additionally containing about 0.5-60% by weight of a polymerizable monomer component composed of one or more compounds selected from formulae I-IX, wherein the polymerizable monomer component polymerizes and/or copolymerizes inefficiently such that it remains significantly or substantially unpolymerized after application and curing of the composition. 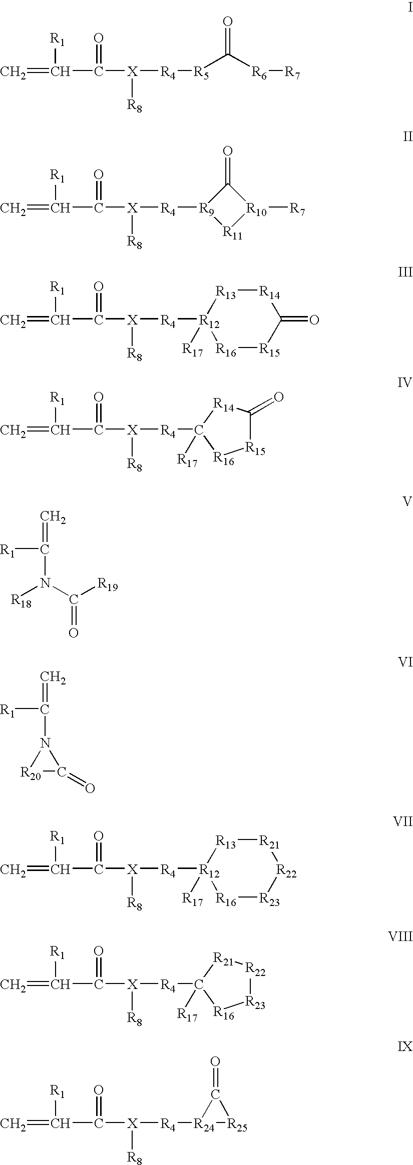
where:
R₁=H, CH₃
X=O, N
R₄=aliphatic or aromatic radical of about 15-1000 g/mol molecular weight containing C, H, and optionally one or more of N, O, S, Si
R₅=O, N, S
R₆=O, N, S
R₇=H, or aliphatic or aromatic radical of about 15-1000 g/mol molecular weight containing C, H, and optionally one or more of N, O, S, Si
R₈=absent when X=O; H, or aliphatic or aromatic radical of about 15-1000 g/mol molecular weight containing C, H, and optionally one or more of N, O, S, Si when X=N
R₉=N
R₁₀=N
R₁₁=aliphatic or aromatic radical of about 15-1000 g/mol molecular weight containing C, H, and optionally one or more of N, O, S, Si
R₁₂=O, N
R₁₃=aliphatic radical having about 1-10 carbon atoms optionally containing N, O, or S
R₁₄=O, NH, S
R₁₅=O, NH, S
R₁₆=aliphatic radical having about 1-10 carbon atoms optionally containing N, O, or S
R₁₇=H, or aliphatic or aromatic radical of about 15-1000 g/mol molecular weight containing C, H, and optionally one or more of N, O, S, Si
R₁₈=H, or aliphatic or aromatic radical with molecular weight about 15-1,000 g/mol
R₁₉=H, or aliphatic or aromatic radical with molecular weight about 15-1,000 g/mol
R₂₀=branched or straight-chained aliphatic, aromatic, or heterocyclic radical with molecular weight of about 14-1,000 g/mol.
R₂₁=O, S, NR₁₇
R₂₂=CHR₁₇
R₂₃=O, S, NR₁₇
R₂₄=N
R₂₅=aliphatic radical having about 1-10 carbon atoms optionally containing N, O, or S

3. Ink compositions comprising compositions of any one of claims 1-2.

4. Adhesive compositions comprising compositions of any one of claims 1-2.

5. Multi-layer prints, laminates, adhesives, and other coated or printed, molded or unmolded, assemblies and articles containing as an intermediate layer a coating, ink, or adhesive produced from the compositions of any one of claims 1-2.

6. Coated and/or printed articles wherein the articles are coated and/or printed with compositions described in any one of claims 1-2.

7. Articles and assemblies of claim 6 of the following types: polymer/polymer laminates, polymer/glass laminates, thermoformed objects, in-mold decorated objects, in-mold coated objects, mirrors, photopolymer printing plates.

8. A process for producing a thermoformed article which comprises coating and/or printing of compositions from any of claims 1-2 onto a polymeric substrate and thermoforming said coated and/or printed substrate to produce a thermoformed article.

9. A process for IMD and IMC which comprises coating and/or printing compositions of any of claims 1-2 onto a polymeric substrate, optionally thermoforming said coated and/or printed substrate, followed by injection molding said substrate to produce an IMD or IMC article or assembly.
